(19) United States
(12) Patent Application Publication
(10) Pub. No.: US 2007/0014593 A1
(43) Pub. Date: Jan. 18, 2007

(54) Electrophotographic image forming apparatus and method

(75) Inventors: Naonori Kurogawa, Suwon-si (KR); Masahiko Itaya, Suwon-si (KR); Kyu-cheol Shin, Seoul (KR); Tsutomu Teraoka, Seongnam-si (KR); Tsutomu Sasaki, Suwon-si (KR); Myung-kook Ahn, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/439,232

(22) Filed: May 24, 2006

(30) Foreign Application Priority Data
Jul. 14, 2005 (KR) 10-2005-0063760

(51) Int. Cl. G03G 15/08

(52) U.S. Cl. 399/281; 399/283; 399/285

(57) ABSTRACT

An electrophotographic image forming apparatus includes: an image receptor on which an electrostatic latent image is formed; a magnetic roller for forming a magnetic brush having a non-magnetic toner and a magnetic carrier by magnetic force; a donor roller facing the image receptor and receiving a toner from the magnetic roller to form a toner layer on an outer circumference thereof; bias applying device for applying a bias voltage to the donor roller to develop the electrostatic latent image by supplying the toner from the toner layer; and toner removing device which contacts the donor roller and removes at least a portion of the toner layer from a surface of the donor roller after developing. A method of developing the latent image on the image receptor is provided by the apparatus.

### CROSS-REFERENCE TO RELATED PATENT APPLICATION

This application claims the benefit of Korean Patent Application No. 10-2005-0063760, filed on Jul. 14, 2005, in the Korean Intellectual Property Office, the disclosure of which is hereby incorporated by reference in its entirety.

### BACKGROUND OF THE INVENTION

1. Field of the Invention

The present invention relates to an image forming apparatus and to a method of developing an image. More particularly, the invention is directed to an electrophotographic image forming apparatus using a magnetic carrier and a non-magnetic toner and a method of developing an image using the magnetic carrier and the non-magnetic toner.

2. Description of the Related Art

Development methods for an image forming apparatus using an electrophotographic technique such as a copy machine, a printer, a facsimile, or a multifunction machine are roughly classified into two-component development methods wherein a toner and a magnetic carrier are used. A one-component method of developing an image uses an insulating toner or a conductive toner. A hybrid development method uses a two-component development material for charging a non-magnetic toner using a magnetic carrier, wherein only charged toners are attached onto a development roller, and the toners are moved to an electrostatic latent image formed on a photoconductive body to develop the electrostatic latent image.

The two-development method has advantages of having good charging properties of the toner. In addition, the lifetime of the toner can be extended, and at the same time, a beta image can be uniformly obtained. On the other hand, an apparatus for developing the image using this method is large and complex, and there are problems of dispersion of a toner, attachment of a carrier onto a latent image, and durability deterioration of the carrier.

In the one component method of developing an image, the development apparatus is compact and the dot-reproducibility is excellent. However, there are disadvantages in that durability is low due to deterioration in the quality of a development roller and a charging roller, the price of consumable parts is high because the entire development apparatus must be replaced when the toner is used up, and a selective development is carried out. During the selective development, a toner having a predetermined weight and electric charge is attached from the development roller to the electrostatic latent image. If the selective development is continuously carried out, a toner having less than the predetermined weight and electric charge is not used in the development process, which leads to a decrease in a toner usage rate.

In the hybrid development method, the dot-reproducibility is excellent, the lifetime can be extended, and a high speed image forming is possible, but development ghosts easily occur. The development ghost is a phenomenon where a latent image of a previously developed image remains on a developed image. A portion of the toner supplied onto a donor roller by a magnetic roller is developed onto a photosensitive material in response to a development bias. In the next development, the magnetic roller supplies the toner to the donor roller, so that the toner consumed in the previous development process is supplemented. In the toner layer on the donor roller, there is a thickness difference between a developed portion and a non-developed portion. Such a disproportion of the toner layer causes the development of ghosts.

### SUMMARY OF THE INVENTION

The present invention provides an electrophotographic image forming apparatus that prevents a development ghost from being generated and prevents the occurrence of an image disproportion even when a printing operation is continuously carried out. The image forming apparatus is thereby able to produce a stable image quality for a long time. The invention is also directed to a method of producing an image using the image forming apparatus.

According to an aspect of the present invention, an electrophotographic image forming apparatus comprises: an image receptor on which an electrostatic latent image is formed; a magnetic roller for forming a magnetic brush by a magnetic force where the magnetic brush is formed from a non-magnetic toner and a magnetic carrier; a donor roller facing the image receptor and receiving toner from the magnetic roller to form a toner layer on an outer circumference of the donor roller; bias applying device for applying a bias voltage to the donor roller to develop the electrostatic latent image on the image receptor by supplying the toner of the toner layer to the image receptor; and toner removing device which contacts the donor roller and removes at least a portion of the toner layer from a surface of the donor roller after developing the latent image.

In the aforementioned electrophotographic image forming apparatus, the toner removing device is positioned on a rotation path parallel to a rotation direction of the donor roller between the closest position between the donor roller and the image receptor and the closest position between the magnetic roller and the donor roller.

In addition, the toner removing device may comprise a wire electrode that is able to contact the donor roller. In addition, a bias voltage applied to the wire electrode may have a bias voltage with a polarity opposite that of the bias voltage applied to the donor roller. In addition, the wire electrode may be grounded.

In addition, the distance between the wire electrode and the donor roller may be 10 to 1,000 μm. In one embodiment, the wire electrode may be covered with an insulating material. An outer diameter of the wire electrode may be 10 to 1,000 μm.

According to another aspect of the present invention, a method of developing an image forms a toner layer on an outer circumference of a donor roller by supplying a toner to the donor roller from a magnetic roller by a magnetic force to form a magnetic brush having a non-magnetic toner and a magnetic carrier, and to apply a bias voltage between the donor roller and a image receptor on which an electrostatic latent image is formed to develop the electrostatic latent image, wherein, after the development of the image is carried out, at least a portion of the toner layer on the donor roller is removed so that a thickness of the toner layer on the outer circumference surface of the donor roller is uniform, and then the toner is supplied again from the magnetic roller to the donor roller.

In the aforementioned aspect of the development method, the wire electrode may be contacted with the donor roller, so that at least a portion of the toner layer on the donor roller can be removed. In other embodiments, the wire electrode may be spaced from the surface of the donor roller a distance of 10 to 1,000 μm, and a bias voltage having a polarity opposite that of the bias voltage applied to the donor roller is applied to the wire electrode, so that the wire electrode contacts the donor roller. In addition, the wire electrode may be spaced from the surface of the donor roller a distance of about 10 to 1,000 μm, and, by grounding the wire electrode, a bias voltage having a polarity opposite to that of the bias voltage applied to the donor roller is applied to the wire electrode, so that the wire electrode contacts the donor roller. In addition, an outer diameter of the wire electrode may be 10 to 1,000 μm and the wire electrode may be covered with an insulating material.

These and other aspects of the invention will become apparent from the following detailed description of the invention which disclose various embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a side view of an electrophotographic image forming according to an embodiment of the present invention;

FIG. 2 is a view illustrating a magnetic brush of the apparatus of FIG. 1;

FIG. 3 is a schematic view illustrating a displacement of toner removing assembly of the apparatus of FIG. 1;

FIGS. 4a and 4b are schematic views illustrating the development of a ghost generating process in a conventional development process;

FIG. 5 is a schematic view of the toner removing device according to an embodiment of the present invention;

FIG. 6 is a schematic view of the toner removing device according to another embodiment of the present invention; and

FIG. 7 is a schematic view illustrating the operation of the toner removing device.

### DETAILED DESCRIPTION OF THE INVENTION

Hereinafter, exemplary embodiments of the present invention will be described in detail with reference to the accompanying drawings.

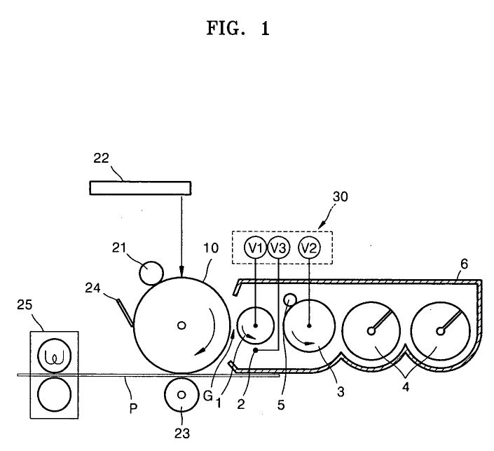

FIG. 1 is a schematic view of a structure of an electrophotographic image forming apparatus according to an embodiment of the present invention. Referring to FIG. 1, the apparatus includes an image receptor 10, a donor roller 1, a magnetic roller 3, and a stirrer 4. In the present embodiment, an organic photosensitive conductor is used as the image receptor 10. Alternatively, an amorphous silicon photosensitive conductor may be used as the image receptor 10. An electrostatic latent image is formed on the image receptor 10, by a charging unit 21 and an exposure unit 22. A corona charger or a charging roller may be used as the charging unit 21. A laser scanning unit (LSU) for illuminating a laser beam may be used as the exposure unit 22. In addition, an electrostatic drum (not shown) may be used as the image receptor 10. In this case, an electrostatic recording head (not shown) may be used instead of the exposure unit 22 to form the electrostatic latent image.

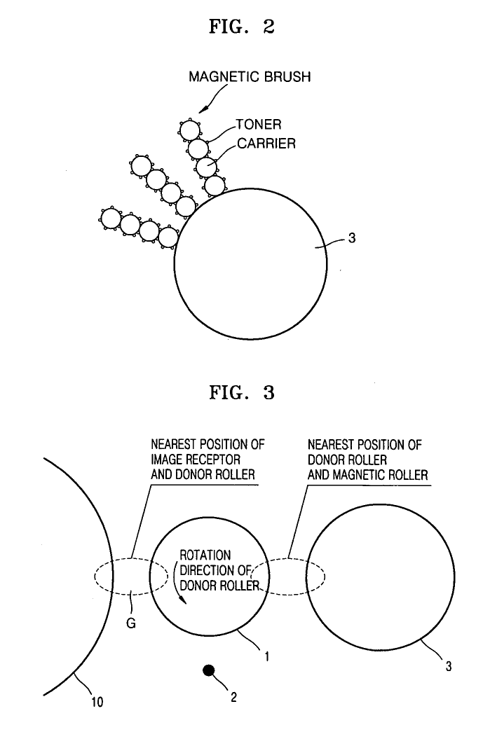

A developer 6 receives a non-magnetic toner and a magnetic carrier. The carrier is not particularly limited except that a magnetic powder type is used. The stirrer 4 stirs the carrier and the toner to frictionally charge the toner. The toner is not particularly limited, and either a negative or positive charged toner is acceptable. The carrier is attached to the outer circumference of the magnetic roller 3 by the magnetic force of the magnetic roller 3, while the toner is attached to the carrier by the electrostatic force. Then, as shown in FIG. 2, a magnetic brush having the carrier and the toner is formed on the outer circumference of the magnetic roller 3. A trimmer 5 forms the magnetic brush to a uniform thickness. The distance between the trimmer 5 and the magnetic roller 3 is preferably 0.3 to 1.5 mm.

The donor roller 1 is disposed between the image receptor 10 and the magnetic roller 3. A gap (development gap G) at the closest point or nearest position between the donor roller 1 and the image receptor 10 is approximately 150 to 400 μm, and preferably 200 to 300 μm. When the development gap G is less than 150 μm, image fading occurs. When the development gap G is greater than 400 μm, it is difficult to move the toner to the image receptor 10 and a sufficient image density is not obtained, which leads to a selective development. The distance at the closest point between the magnetic roller 3 and the donor roller 1 is approximately 0.2 to 1.0 mm, and preferably 0.3 to 0.4 mm. The donor roller 1 has a cylindrical shape and is made of a conductive aluminum or a stainless steel having an intrinsic volume resistance approximately less than 10⁶Ω·cm³. Alternatively, the outer circumference of the donor roller 1 is covered with a conductive resin having the same intrinsic volume resistance.

Bias applying device 30 applies a development bias voltage V1 and a supply bias voltage V2 to the donor roller 1 and the magnetic roller 3, respectively. The supply bias voltage V2 generates an electric field to transfer the toner from the magnetic roller 3 to the donor roller 1, between the magnetic roller 3 and the donor roller 1, and is a bias voltage having a direct current or a combined current of direct and alternating currents. A toner layer is formed on an outer circumference of the donor roller 1 in response to the supply bias voltage V2. The development bias voltage V1 must separate the toner from the toner layer formed on the outer circumference of the donor roller 1 to make the toner pass across the development gap G to develop the electrostatic latent image on the image receptor 10. To this end, the development bias voltage V1 includes a direct current or a combined current of direct and alternating currents. In the present embodiment, the DC development bias voltage V1 is applied to the donor roller 1.

According to the embodiment of FIG. 1, the charging unit 21 equipotentailly charges the surface of the image receptor 10, which is a photosensitive conductor. The exposure unit 22 illuminates light corresponding to image data onto the image receptor 10. In this manner, an electrostatic latent image having an image portion and a non-image portion having electric potentials are different from each other is formed on the surface of the image receptor 10. In response to the supply bias voltage V2 applied to the magnetic roller 3, the toner is separated from the magnetic brush to be supplied to the donor roller 1. A toner layer is uniformly formed on the outer circumference of the donor roller 1. If the toner layer formed on the donor roller 1 faces the image portion of the electrostatic latent image while passing through the development gap G, the toner is separated from the toner layer on the donor roller 1 based on the development bias voltage V1 and attached to the image portion so as to develop the electrostatic latent image into a visible toner image. The toner image is transferred to a recording medium P by a transfer electric field generated by a transfer unit 23. A fuser 25 fuses the toner image onto the recording medium P by heat and pressure, and a cleaning blade 24 removes toner remained on the surface of the image receptor 10.

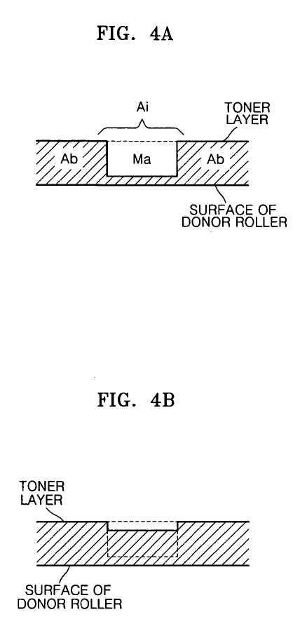

Referring to FIG. 4a, the toner layer formed on the surface of the donor roller 1 passes through the development gap G, and a portion or all of the toner layer in the area Ai facing with the image portion of the image receptor 10 is developed onto the image receptor 10 based on the development bias voltage V1. The toner layer in the area Ab facing the non-image portion of the image receptor 10 is not developed but remains on the surface of the donor roller 1. In the electrostatic latent image formed on the image receptor 10, the image portion and the non-image portion respectively represent an area where the toner is attached and a background area where the toner is not attached. The amount of the toner developed from the area Ai to the image receptor 10 is referred to as Ma. For a next development cycle, the magnetic roller 3 supplies the toner onto the area Ai. Where the image is continuously printed or the amount of the toner remaining in the developer 6 is not sufficient to produce an image, the amount of the toner supplied from the magnetic roller 3 to the donor roller 1 may be less than Ma. Then, as shown in FIG. 4(b), the thickness of the toner layer formed on the surface of the donor roller 1 is not uniform, which leads to a development ghost since a latent image of the previous development remains in the next development process cycle.

The image forming apparatus according to the present invention includes toner removing device for removing at least a portion of the toner layer from the donor roller 1 after a development cycle. The toner removing device removes a portion or all of the toner layer of the donor roller 1 after the toner layer on the surface of the donor roller 1 passes through the development gap G and before the toner is supplied from the magnetic roller 3.

Referring to FIGS. 1 and 3, a wire electrode 2 is oriented parallel to the axis of rotation of the donor roller 1 between the closest point or nearest position between the donor roller 1 and the image receptor 10 and the closest point or nearest position between the magnetic roller 3 and the donor roller 1. The definitions of the nearest position between the magnetic roller 3 and the donor roller 1 and the nearest position between the donor roller 1 and the image receptor 10 are shown in FIG. 3. The wire electrode 2 is oriented with respect to the donor roller 1 to remove the toner layer from the surface of the donor roller 1 while the donor roller surface passes through the development gap G. The wire electrode 2 may be disposed to contact the surface of the donor roller 1.

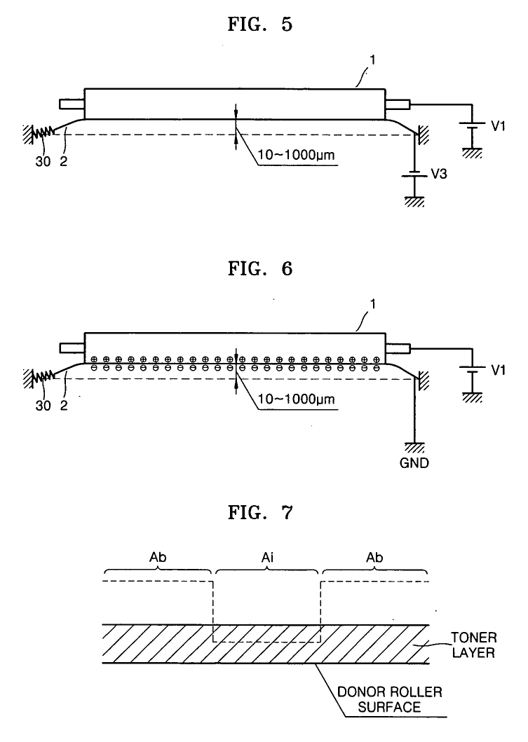

In another example, as shown in FIG. 5, the wire electrode 2 is positioned to be separated from the surface of the donor roller 1 by a predetermined distance, and a bias voltage V3 having a polarity opposite to that of the bias voltage V1 applied to the donor roller 1 is applied to the wire electrode 2. The bias voltage V3 is applied, for example, by the bias applying device 30. When the toner is positively charged, for example, the bias voltage V1 having a positive polarity like the charged toner, is applied to the donor roller 1. The bias voltage V3 having a negative polarity is applied to the wire electrode 2. Then, the wire electrode 2 deflects and contacts the donor roller 1 by the electrostatic attraction force between the wire electrode 2 and the donor roller 1.

In an alternative embodiment, as shown in FIG. 6, the wire electrode 2 may be separated from the surface of the donor roller 1 by a predetermined distance, and the electrode wire is grounded. A charge having an opposite polarity with respect to the bias voltage V1 applied to the donor roller 1 is induced into the grounded wire electrode 2 so that the wire electrode 2 contacts the donor roller 1 by the electrostatic attraction force. In this manner, by grounding the wire electrode 2, the degree of freedom in selecting the bias voltage V1 increases.

Springs 30 apply biasing force to the wire electrode 2. The springs 30 may be positioned at each end of the wire electrode 2 or at one end as shown in FIGS. 5 and 6. The distance between the wire electrode 2 and the surface of the donor roller 1 is preferably 10 to 1,000 μm. If the distance is less than 10 μm, it becomes difficult to maintain a uniform distance between the wire electrode 2 and the surface of the donor roller 1 along the donor roller 1. If the distance is greater than 1,000 μm, it becomes difficult to contact the wire electrode 2 with the donor roller 1. A distance in the range of 10 to 1,000 μm, therefore, is the most suitable to remove the toner layer from the surface of the donor roller 1. The thickness of the wire electrode 2 is preferably in the range of the 10 to 1,000 μm. If the thickness of the wire electrode 2 is less than 10 μm, the rigidity and strength of the electrode is not sufficient, and if the thickness of the wire electrode 2 is greater 1,000 μm, the rigidity thereof becomes too high and the wire electrode 2 cannot flex and contact the donor roller 1. In the embodiments shown, the wire electrode 2 extends substantially parallel to the axis of rotation of the donor roller 1 and extends the entire length of the donor roller 1. As shown, the wire electrode 2 is positioned downstream of the closest point between the donor roller 1 and the image receptor 10 with respect to the direction of rotation of the donor roller and upstream of the closest point between the donor roller and the magnetic roller 3.

In order to prevent the wire electrode 2 from being electrically short-circuited when contacting the donor roller 1, the wire electrode 2 is preferably covered with an insulating material such as a vinyl chloride.

When the wire electrode 2 contacts the surface of the donor roller 1 after surface of the donor roller 1 has passed through the development gap G, as shown in FIG. 7, a portion of the non-image area Ab is removed from the surface of the donor roller 1, and another portion thereof is moved to the image area Ai, so that a thickness of the toner layer on the surface of the donor roller 1 becomes uniform. Of course, the toner layer on the surface of the donor roller 1 may be entirely removed.

Accordingly, in the method of developing an image of the present invention, before the toner is supplied from the magnetic roller 3 to the donor roller 1, a portion or all of the toner layer on the donor roller 1 is removed or redistributed, so that a thickness of the toner layer on the donor roller 1 becomes more uniform. Therefore, a latent image of the previous development is removed from the donor roller 1. Next, the toner is supplied from the magnetic roller 3 to the donor roller 1, so that the toner layer having a uniform thickness is formed on the surface of the donor roller 1 which then passes through a development gap G. Thus, not only where an image is developed on a single-time base, but also in a case where the image is continuously developed, the thickness of the toner layer can be uniformly formed on the donor roller 1, so that formation of a development ghost can be prevented. In particular, the method of the present invention is remarkably efficient in preventing the formation of the development ghost when an image of high density is continuously developed, so that a stable image quality can be obtained.

Although in the above description, a monochrome image forming apparatus and a development method therefor have been described, the image forming apparatus and the development method therefor according to the present invention can be applied to a single-pass type color image forming apparatus having a tandem configuration and a multi-pass type color image forming apparatus in which a single image receptor is repeatedly developed and developed images are sequentially transferred to a intermediary transfer unit.

While the present invention has been particularly shown and described with reference to exemplary embodiments thereof, it is not limited thereto, and various changes in form and details may be made therein within the spirit and scope of the present invention as defined by the appended claims.

What is claimed is:

1. An electrophotographic image forming apparatus comprising:
an image receptor on which an electrostatic latent image is formed;
a magnetic roller for forming a magnetic brush by magnetic force, wherein the magnetic brush is formed from a non-magnetic toner and a magnetic carrier;
a donor roller facing the image receptor and receiving a toner from the magnetic roller to form a toner layer on an outer circumference of the donor roller;
bias applying device for applying a bias voltage to the donor roller to develop the electrostatic latent image on the image receptor by supplying the toner from the toner layer on the donor roller; and
toner removing device for contacting the donor roller and removing at least a portion of the toner layer from a surface of the donor roller after supplying the toner to the image receptor to develop the image.

2. The apparatus of claim 1, wherein the toner removing device is positioned along an axis parallel to the rotation direction of the donor roller and positioned between the closest point between the donor roller and the image receptor and the closest point between the magnetic roller and the donor roller.

3. The apparatus of claim 2, wherein the toner removing device comprises a wire electrode that can contact the donor roller.

4. The apparatus of claim 3, wherein a bias voltage is applied to the wire electrode having a polarity opposite to the bias voltage applied to the donor roller.

5. The apparatus of claim 4, wherein the wire electrode is spaced from the donor roller a distance of 10 to 1,000 μm.

6. The apparatus of claim 5, wherein the wire electrode is covered with an insulating material.

7. The apparatus of claim 6, wherein an outer diameter of the wire electrode is 10 to 1,000 μm.

8. The apparatus of claim 3, wherein the wire electrode is grounded.

9. The apparatus of claim 8, wherein the wire electrode is spaced from the donor roller a distance of 10 to 1,000 μm.

10. The apparatus of claim 9, wherein the wire electrode is covered with an insulating material.

11. The apparatus of claim 10, wherein an outer diameter of the wire electrode is 10 to 1,000 μm.

12. The apparatus of claim 1, wherein the toner removing device is a flexible wire electrode spaced from the donor roller and oriented along an axis parallel to an axis of rotation of the donor roller, and wherein a bias voltage is applied to the donor roller and to the electrode wire to produce an attracting force whereby the electrode wire contacts the surface of the donor roller.

13. The apparatus of claim 12, wherein said electrode wire is coupled to a spring whereby the electrode wire can be deflected toward the donor roller.

14. The apparatus of claim 12, wherein the electrode wire positioned downstream of a closest point between the donor roller and the image receptor with respect to the direction of rotation of the donor roller, and upstream of a closest point between the donor roller and the magnetic roller.

15. A method of developing a toner image on an electrostatic latent image on an image receptor comprising forming a toner layer on an outer circumference of a donor roller by supplying a toner to the donor roller from a magnetic roller, the magnetic roller forming a magnetic brush from a non-magnetic toner and a magnetic carrier by a magnetic force, applying a bias voltage between the donor roller and the image receptor to develop the electrostatic latent image, and after the electrostatic latent image is developed, at least a portion of the toner layer on the donor roller is removed to form a toner layer on the outer circumference surface of the donor roller having uniform thickness, and thereafter supplying toner from the magnetic roller to the donor roller.

16. The method of claim 15, wherein a wire electrode contacts the donor roller to remove at least a portion of the toner layer on the donor roller after the latent image is developed.

17. The method of claim 15, wherein the wire electrode is spaced from the surface of the donor roller a distance of 10 to 1,000 μm, and a bias voltage is applied to the wire electrode having a polarity opposite to that of the bias voltage applied to the donor roller, so that the wire electrode is deflected and contacts the donor roller.

18. The method of claim 17, wherein the wire electrode is covered with an insulating material.

19. The method of claim 18, wherein the wire electrode has an outer diameter of 10 to 1,000 μm.

20. The method of claim 16, wherein the wire electrode is spaced from the surface of the donor roller a distance of 10 to 1,000 μm, and wherein the wire electrode is grounded and a bias voltage is applied to the wire electrode having a bias voltage with polarity opposite the bias voltage applied to the donor roller so that the wire electrode is deflected and contacts the donor roller.

21. The method of claim 20, wherein the wire electrode is covered with an insulating material.

22. The method of claim 21, wherein the wire electrode has an outer diameter of 10 to 1,000 μm.

23. The method of claim 16, wherein the wire electrode is oriented along an axis parallel to an axis of rotation of the donor roller and where a bias voltage is applied to the wire electrode that is opposite to the bias voltage applied to the donor roller, whereby the electrode wire is deflected and contacts the donor roller.
